(19) United States
(12) Patent Application Publication
(10) Pub. No.: US 2007/0129999 A1
(43) Pub. Date: Jun. 7, 2007

(54) Fraud detection in web-based advertising

(76) Inventors: Jie Zhou, Mountain View, CA (US); Chirag Khopkar, Seattle, WA (US); Asher Walkover, Palo Alto, CA (US); Peter Kappler, Austin, TX (US); Charity Yueh-chwen Lu, Los Altos, CA (US)

Correspondence Address: GOOGLE / FENWICK, SILICON VALLEY CENTER, 801 CALIFORNIA ST., MOUNTAIN VIEW, CA, 94041, US

(21) Appl. No.: 11/282,971

(22) Filed: Nov. 18, 2005

(51) Int. Cl. G06Q 30/00

(52) U.S. Cl. 705/14

(57) ABSTRACT

Attributes of new account information and advertising campaigns for advertisers are evaluated by a fraud detection engine of a fraud system and a fraud score is augmented where fraud is suspected. The fraud detection engine evaluates the attributes of the advertising campaign, including attributes such as bid amount, maximum cost per day, average bid, and keyword selection.

### CROSS-REFERENCE TO RELATED APPLICATIONS

This application is related to the following U.S. Patent Applications, each of which is incorporated by reference herein in its entirety:

application Ser. No. 11/201,754, titled “Generating and Presenting Advertisements Based on Context Data for Programmable Search Engines,” filed on Aug. 10, 2005;

application Ser. No. 10/112,654, titled “Methods And Apparatus For Ordering Advertisements Based On Performance Information And Price Information,” filed on Mar. 29, 2002;

application Ser. No. 10/314,427, titled “Methods And Apparatus For Serving Relevant Advertisements,” filed on Dec. 6, 2002; and

application Ser. No. 10/375,900, titled “Serving Advertisements Based On Content,” filed Feb. 26, 2003.

### BACKGROUND OF THE INVENTION

1. Field of the Invention

The present invention relates generally to fraud detection in Internet commerce. In particular, the present invention is directed towards detecting fraud associated with the purchase of advertising campaigns on the web.

2. Description of the Related Art

Internet commerce, in particular the buying and selling of goods and services over the web, has a degree of associated fraudulent activity. One reason for the proliferation of fraud on the web is that online transactions do not require the physical presence of participants. For online merchants, there are two different types of fraud to try to detect. In the first case, a credit card is stolen and then used to purchase goods. In the second case, sometimes referred to as “friendly fraud,” a consumer uses his own credit card to purchase items on a web site, and then upon receiving the bill claims that he did not authorize the transaction or receive the merchandise.

One area of Internet commerce susceptible to fraudulent transactions is that of web-based advertisements. Fraudsters use stolen credit cards to purchase advertising campaigns designed to drive ads to their web sites, in turn gaining revenue from those hits. By using multiple advertising accounts, a steady stream of hits is insured even when some fraudulent accounts are detected and deactivated.

Conventional fraud detection methods detect some but not all fraudulent activity, as they do not take advantage of the particular properties of online advertising to detect fraudulent advertising accounts.

### SUMMARY OF THE INVENTION

The present invention enables greater fraud detection in web-based advertising campaigns. An advertiser wishing to initiate an advertising campaign provides information to an advertising system in order to set up an advertiser account. A fraud detection engine of a fraud system evaluates various attributes of the account including the advertiser's IP address, the presence of site-related cookies on the advertiser's computer, and the advertiser's domain. If the result of any of these evaluations suggests an increased likelihood of fraud, a fraud score for the transaction is determined. The fraud detection engine also evaluates attributes of the advertiser's advertising campaign for elements of fraud. The amount bid by the advertiser may be evaluated against other bids by other advertisers for similar keywords or keyword groups—unusually high bids are suggestive of fraudulent activity. The advertiser's maximum cost per day is projected based on historical values for the bid amount and specified keywords, and an unusually high maximum cost is flagged as potentially fraudulent. For any of the specified keywords, excessive deviation from the average bid for that keyword also augments the fraud score. The fraud detection engine may also check the bid amount against the same advertiser's previous bid amounts, where available, since sudden changes in bid amounts for a similar set of keywords indicates potential fraud. Content of the page identified by the URL specified in the advertising impression is compared to a list of known fraud patterns to evaluate whether the target site is associated with fraudulent activity—if so, the fraud score is augmented. Finally, the text of the impressions can be compared to the text of other impressions by other advertisers for the same keywords. Highly similar advertisement text for highly similar keywords across multiple accounts suggests that the same advertiser is operating multiple accounts, which is an indicator of fraud, and the fraud score is again augmented. Following these evaluations, the fraud score is compared to a threshold score. If the fraud score is higher than the threshold, the transaction is deemed fraudulent. If the transaction is lower than the score, the transaction is deemed not fraudulent. In one embodiment, a fraud score near to the threshold is referred to a case management module for further investigation by a fraud analyst.

The features and advantages described in this summary and the following detailed description are not all-inclusive. Many additional features and advantages will be apparent to one of ordinary skill in the art in view of the drawings, specification, and claims hereof. Moreover, it should be noted that the language used in this disclosure has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram of a system for detecting fraud in online advertising campaigns in accordance with an embodiment of the present invention.

FIG. 2 is a block diagram further illustrating an advertising system and a fraud system in accordance with an embodiment of the present invention.

FIG. 3 is a flowchart illustrating a method for detecting fraud in online advertising in accordance with an embodiment of the present invention.

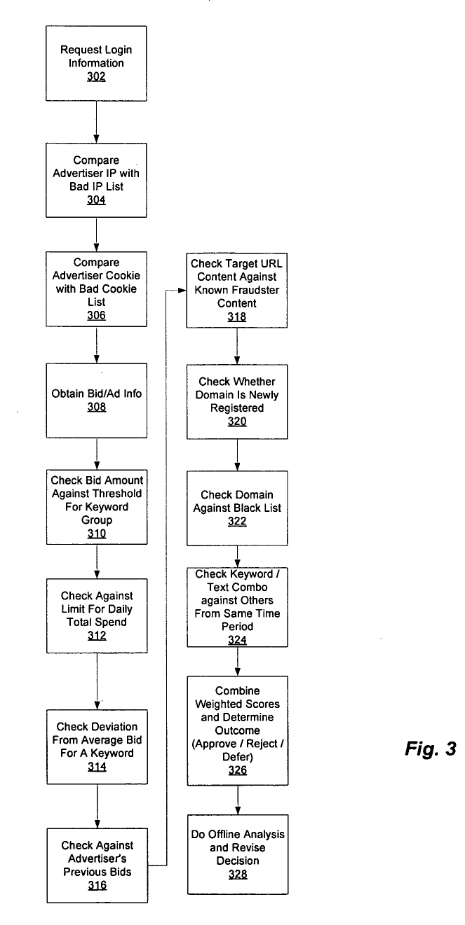

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

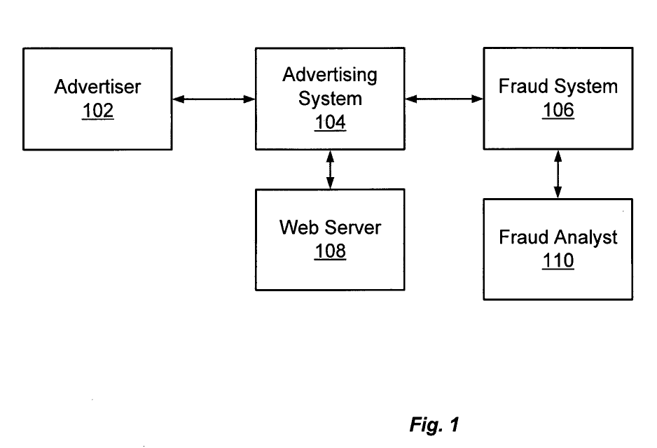

FIG. 1 illustrates one implementation of the present invention. An advertiser 102 communicates with an advertising system 104 in order to establish an advertising campaign, as described further below, creating a new account if one does not already exist. Attributes of the advertiser's advertising campaign and the advertiser's account are passed to fraud system 106, which determines based on the attribute information whether there is a significant likelihood of fraud associated with the transaction. If the transaction is found by fraud system 106 to be fraudulent, the advertising campaign is rejected. If the transaction is found by the fraud system 106 to likely not be fraudulent, the campaign is accepted, subject to any other business rules in place by advertising system 104. Visitors to web server 108 are then able to view the advertiser's advertisements, again in accordance with the terms of the advertising campaign and the advertising system's business logic. In those cases where fraud system 106 is not able to determine whether a transaction is fraudulent or not fraudulent with more than a threshold degree of certainty, the transaction is flagged for review by a fraud analyst 110.

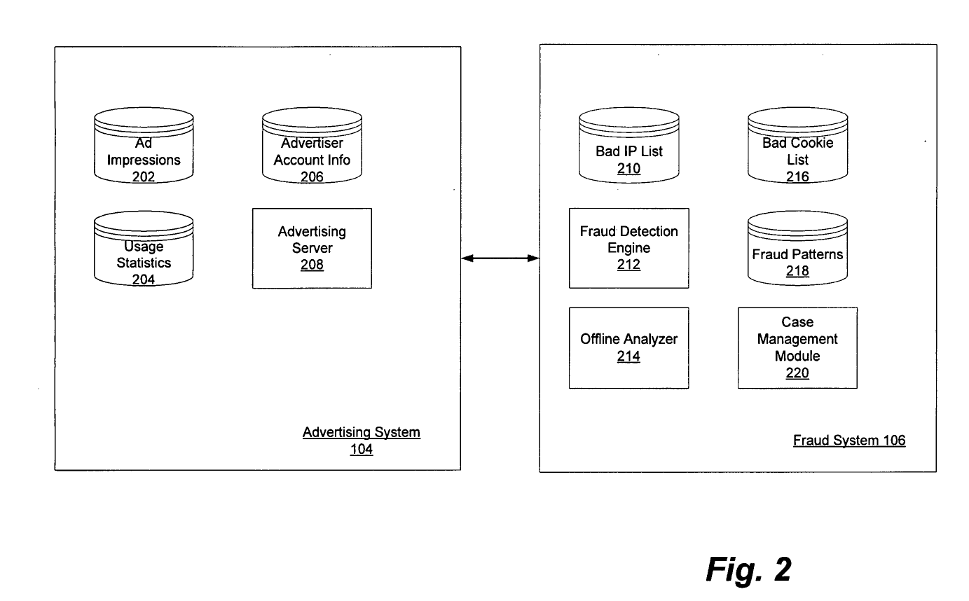

FIG. 2 provides a more detailed view of advertising system 104 and fraud system 106 in accordance with an embodiment of the present invention. Advertising system 104 includes components and modules used for obtaining campaign information from an advertiser 102, communicating with fraud system 106 to determine whether an advertiser 102 or campaign is legitimate or fraudulent, and for providing the advertising impressions to an associated web server 108 at an appropriate time.

Advertising system 104 includes an advertising server 208, responsible for accepting campaigns from an advertiser 102, requesting a fraud determination from fraud system 106, and serving ads to web server 108. Advertising impressions are stored in an ad impressions database 202. Advertiser account information is stored in advertiser account information database 206. Usage statistics including aggregate and specific information from previous campaigns is stored in usage statistics database 204, as detailed further below.

Fraud system 106 includes a fraud detection engine 212, which receives transaction data about advertisers and campaigns from advertising system 104 and determines whether the transaction is likely fraudulent. If fraud detection engine 212 is not able to make a confident determination of whether the new account and/or new campaign is fraudulent, the case is referred to case management module 220 for subsequent review by a fraud analyst 110. Fraud system 106 additionally contains a bad IP list database 210, for storing a list of IP addresses known to be associated with fraudulent activity; a bad cookie list 216, for storing a list of cookies known to be associated with fraudulent activity; and fraud patterns database 218, for storing pattern information extracted from web pages known to be associated with fraud, the patterns describing page content and layout features that are associated with web pages hosted by fraudsters. Fraud system 106 also includes an offline analyzer 214, for performing additional evaluations of transactions where a real-time fraud/no-fraud decision is not required.

Note that while FIG. 1 and FIG. 2 illustrate one-to-one relationships between the advertising system 104, fraud system 106 and web server 108, this is for purposes of clarity only—for example, a single advertising system 104 could easily support many instances of web server 108; more or fewer databases (both logically and physically) can form part of advertising system 104 and fraud system 106, etc. In addition, advertising system 104 and fraud system 106 need not be different systems, either logically or physically. The arrangement of the described functional components is one chosen by the implementer according to his particular needs.

Web-based advertising campaigns typically involve either a cost-per-click or a cost-per-impression payment scheme, as is known in the art. In a cost-per-click model, advertisers are charged a fee each time a visitor to the site hosting the ad clicks on a link associated with the advertisement. In a cost-per-impression model, advertisers pay a fee each time their advertisement, known as an impression, is displayed, regardless of whether it is clicked on by a visitor. Some advertising system operators sell advertising space at a fixed rate—for example, either per click or per ad impression. Others charge different rates depending on the subject of the advertisement. One site, operated by Google Inc., of Mountain View, Calif., provides a service called AdWords, which allows advertisers to bid on advertising space, using either a cost-per-click or cost-per-impression approach. Any of the web-based advertising managements system may be used in connection with the present invention.

Referring now to FIG. B there is shown a flowchart illustrating a method for detecting fraud in online advertising in accordance with an embodiment of the present invention. An advertiser 102 accesses advertising system 104 and advertising system 104 requests 302 the advertiser's login account information. If the advertiser 102 does not yet have an account with advertising system 104, then advertising server 208 prompts the advertiser 102 to create a new account. If the advertiser 102 does have an account, then he provides the information to advertising server 208 in order to be authenticated according to data in the advertiser account information database 206.

Once a new account has been created or an existing account has been validated, fraud system 106 compares 304 the IP address associated with the advertiser against a list of known bad IP addresses, i.e. a record of IP addresses known to have been used by fraudsters in the past. Because an IP address does not uniquely identify an advertiser, for example such as when two advertisers both use the same public workstation or when two advertisers have dynamic IP addresses assigned by a common Internet service provider, a match against the bad IP list is not necessarily dispositive of fraud—it may be only a factor used in assessing the overall trustworthiness of the advertiser, in combination with other analyses as described below.

If the advertiser's IP address matches an IP address on the list of known bad IP addresses, then in one embodiment a fraud score for the transaction is augmented by a certain amount. The amount by which the fraud score is augmented is preferably configurable by the operator of fraud system 106, and reflects the degree to which the operator wishes to weigh a bad IP address compared to weight given other tests of fraud. When combined with other fraud detection steps outlined below, if the fraud score is above a threshold level, the transaction is determined to be fraudulent.

In an alternative embodiment, a match against the bad IP list 210 augments a counter. Other indications of fraudulent activity, as described below, also augment the counter. If the counter is augmented beyond a threshold level, the transaction is determined to be fraudulent.

Next, system 106 checks 306 to see whether the advertiser has any site-created cookies on the advertiser's computer. In one embodiment, system 106 places a cookie on the advertiser's computer when the advertiser establishes an account with the system. If a user claiming to be a new advertiser attempts to establish an account but already has a cookie on his computer, this again is indicative of fraudulent activity by the advertiser, and the fraud score is updated accordingly. Again, the existence of the cookie could be, but need not be, dispositive of fraudulent activity—for example, multiple advertisers could share a single computer. In addition, any cookies on the advertiser's computer when the advertiser is not registering a new account are compared against a list of cookies known to be associated with previous fraudulent activity. If there is a match, the fraud score is augmented.

Next, advertiser 102 provides 308 advertising system 104 with information about the campaign the advertiser wishes to bid on. The information preferably includes one or more impressions, one or more keywords or keyword groups, and a bid amount. The impression typically also includes a URL for the advertiser's site. Providing bids for advertisements is further described in U.S. patent application Ser. No. 11/201,754, titled “Generating and Presenting Advertisements Based on Context Data for Programmable Search Engines,” filed on Aug. 10, 2005, which is incorporated by reference herein in its entirety.

An advertising campaign comprises advertising text along with a set of keywords, for which the advertiser places a bid in order to promote advertisements in response to queries containing one or more of the keywords. In one embodiment, keywords are part of keyword groups. The particular groupings are variable according to the particular requirements of the implementer, but in one embodiment the keyword groups are made up of keywords that describe similar concepts—for example, “autos”, “cars”, “trucks”, and “vehicles” might be part of the same keyword group, such an “automotive.” The advertiser's bid for the keyword group is compared with the bids of other advertisers and one or more of the advertisers are selected based, at least in part, on their respective bid amounts. An advertiser may establish multiple keyword groups, each with an associated bid amount. Advertising system 104 includes usage statistics database 204, which has a record of average bid amounts for each keyword group, based on the bid amounts of different advertisers for keywords in that group. In addition, a threshold fraudulent bid amount is preferably associated with each keyword group, and in one embodiment is related to the average bid amount. For example, a threshold fraudulent bid amount may be two standard deviations greater than the average bid amount for the keyword group. In an alternative embodiment, the threshold fraudulent bid amount is set manually, or according to other criteria. When advertiser 102 provides the set of keywords and bid amount, fraud detection engine 212 compares 310 the provided bid against the threshold for the keyword group. If the bid is higher than the fraudulent bid threshold, fraud may be indicated, and the fraud score is augmented. Note that a particular advertiser may have independent reasons for placing a legitimately high bid for a particular advertising campaign, and thus a high bid may or may not be dispositive standing alone.

In one embodiment, fraud system 106 predicts a daily total spend amount for the specified bid and keywords supplied by advertiser 102. For example, using historical information from usage statistics database 204 about the number of impressions shown for a given keyword and a given bid amount, fraud system 106 can predict the total number of clicks or total number of impressions that will be generated. Multiplying the predicted number of daily clicks or impressions by the cost-per-click or cost-per-impression yields the expected daily spend amount by the advertiser. If this amount exceeds 312 a maximum amount, then the fraud score is augmented. The maximum amount may be set manually, or may be derived according to a particular formula—for example two standard deviations above the mean daily spend for the keyword, or keyword group.

In one embodiment, fraud system 106 compares 314 the advertiser's bid amount for the specified keyword or keyword group against a historical average for the keyword using usage statistics database 204. If the advertiser's bid deviates by more than a threshold amount from the average, the fraud score is augmented. In one embodiment, fraud system 106 also compares 316 the advertiser's bid amount against the advertiser's previous bids. If the advertiser is bidding an amount substantially higher, e.g., more than 50% higher than the advertiser has historically bid, the fraud score is augmented. This comparison is useful for detecting an advertiser's account that has been compromised by a fraudster.

Next, fraud detection engine analyzes 318 the target URL supplied by advertiser 102 using fraud patterns maintained in fraud patterns database 218. If the target URL includes patterns found in the fraud patterns database 218, it is potentially affiliated with fraudulent activity, and the fraud score is therefore augmented by fraud detection engine 212.

Next, fraud detection engine checks 320 the registration date for the domain of the target URL. If the domain was recently registered, this is an indication of potential fraud, and the fraud score is augmented. Similarly, the domain is compared 322 against a black list, and if the domain is present on the black list the fraud score is augmented. The black list preferably includes not only the domain name itself, but also the name and address of individuals or companies associated with the domain, and this information is also compared against the black list.

In one embodiment fraud detection engine 212 checks 324 for overlap between keyword groups and the text of impressions provided by purportedly different advertisers 102—that is, advertisements that originated from different advertiser accounts. If there is a substantial similarity between the text of the current impression and the text of other impressions for the same or similar keywords, this is an indication of fraudulent activity. In particular, it is an indication that the advertiser 102 is creating a duplicate account—which may itself be fraudulent, depending on the terms of service of the advertising system 104. In addition, existence of duplicate accounts is consistent with fraud because a fraudster will open new accounts to replace those that are detected and confiscated. To detect duplicates, for all accounts created within a given time period, for example a day or a week, fraud detection engine 212 compares the keyword groups and the advertisement texts. If some number greater than a first threshold, for example 90%, of the keywords between two accounts are the same, and some number greater than a second threshold, for example 90%, of the text of the impressions are the same, then the accounts are considered to be duplicates and are flagged as potentially fraudulent. In one embodiment the accounts are only flagged if a certain minimum number of accounts, e.g., three, are found to be duplicates of each other.

In one embodiment, as described above, a fraud score is determined by combining results of the different described fraud analyses, each type of analysis given a desired weight; in other words the fraud score may be a linear combination of weights associated with the various fraud detection rules described above. Fraud detection engine 212 determines 326 whether the final fraud score is greater than a final fraud threshold amount. If so, then the transaction is determined to be fraudulent, and the advertising campaign and/or the new account is rejected. If the fraud score is lower than the threshold amount, the transaction is determined to not be fraudulent, and the advertising campaign is rejected. In one embodiment, if the fraud score is within a predefined range close to the threshold score (e.g., within +/−10% of the threshold score), the transaction is identified as potentially fraudulent and queued in case module 220 for subsequent review by a fraud analyst 110. Alternatively, an upper, a lower and some number of intermediate thresholds may be used to selectively categorize an account as to the likelihood of being fraudulent. The categorized accounts can then be processed, e.g., by approval, rejection, or queuing to case management as desired by the system implementer.

In one embodiment, while fraud detection engine 212 determines a fraud/no-fraud/undetermined response in real-time, certain transactions are subsequently passed 328 to offline analyzer 214 for further analysis. For example, a pattern analysis such as is described above with respect to step 318 can be performed by offline analyzer 214 so as to reduce the load and latency in real-time analyses performed by fraud detection engine a02.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the fraud detection engine 212 and so forth may be provided in many or one module.

Some portions of the above description present the feature of the present invention in terms of algorithms and symbolic representations of operations on information. These algorithmic descriptions and representations are the means used by those skilled in the online advertising arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality. It should be borne in mind, however, that all of these and similar terms are to be associated with the appropriate physical quantities and are merely convenient labels applied to these quantities.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method for detecting fraudulent advertising transactions over a network, the method comprising:
receiving first advertising information from a first advertiser, the first advertising information including a first plurality of keywords and first advertising text;
identifying second advertising information received from a second advertiser, the second advertising information including a second plurality of keywords and second advertising text,
wherein the second plurality of keywords includes more than a first threshold number of keywords also in the first plurality of keywords, and the second advertising text includes more than a second threshold amount of text also in the first advertising text; and
determining that the first advertiser and the second advertiser are the same advertiser.

2. A method for detecting fraud in an online advertising campaign, the method comprising:
receiving a proposed advertising transaction from an advertiser, the advertiser having attributes, the transaction including a bid amount, at least one impression, and at least one keyword;
determining from the advertiser attributes and the proposed transaction a likelihood that the proposed transaction is fraudulent; and
responsive to the likelihood exceeding a threshold, refusing the proposed advertising transaction.

3. The method of claim 2 wherein the advertiser attributes include an IP address, and determining the likelihood further comprises comparing the advertiser's IP address with a set of IP addresses associated with fraud.

4. The method of claim 2 wherein the advertiser attributes include a cookie, and determining the likelihood further comprises comparing the advertiser's cookie with a set of cookies associated with fraud.

5. The method of claim 2 wherein the advertiser attributes include a domain name, and determining the likelihood further comprises comparing the advertiser's domain name with a set of domain names associated with fraud.

6. The method of claim 2 wherein determining the likelihood further comprises comparing the bid amount of the proposed transaction with bid amounts of other transactions, each of the other transactions having the same keywords as the proposed transaction.

7. The method of claim 6 wherein the other transactions were made by the advertiser.

8. The method of claim 2 wherein determining the likelihood further comprises estimating a cost for the proposed transaction and determining whether the estimated cost exceeds a threshold amount.

9. The method of claim 2 wherein the proposed transaction additionally includes a URL associated with the advertiser, and determining the likelihood further comprises comparing content of a web page identified by the URL to known fraud patterns.

10. A system for detecting fraud in a web-based advertising campaign comprising:
an advertising server for receiving a proposed advertising transaction from an advertiser, the advertiser having attributes, the transaction including a bid amount, at least one impression, and at least one keyword;
a fraud server, coupled to the advertising server, for:
determining from the advertiser attributes and the proposed transaction a likelihood that the proposed transaction is fraudulent; and
responsive to the likelihood exceeding a threshold, refusing the proposed advertising transaction.

11. A computer program product for detecting fraud in an online advertising campaign, computer program product stored on a computer-readable medium and including instructions for causing a computer to carry out the steps of:
receiving a proposed advertising transaction from an advertiser, the advertiser having attributes, the transaction including a bid amount, at least one impression, and at least one keyword;
determining from the advertiser attributes and the proposed transaction a likelihood that the proposed transaction is fraudulent; and
responsive to the likelihood exceeding a threshold, refusing the proposed advertising transaction.
